(19) United States
(12) Patent Application Publication
(10) Pub. No.: US 2016/0217682 A1
(43) Pub. Date: Jul. 28, 2016

(54) HEAT DETECTOR

(71) Applicant: SPRUE SAFETY PRODUCTS LTD., Coventry (GB)

(72) Inventors: Peter Brigham, Coventry (GB); Chris Bolger, Coventry (GB)

(21) Appl. No.: 14/915,558

(22) PCT Filed: Aug. 21, 2014
(86) PCT No.: PCT/GB14/52564

§ 371 Date: Feb. 29, 2016

(30) Foreign Application Priority Data
Sep. 4, 2013 (GB) 1315697.1

(51) Int. Cl. G08B 29/14; G08B 17/10; G08B 17/06

(52) U.S. Cl. CPC G08B 29/145; G08B 17/06; G08B 17/10

(57) ABSTRACT

A heat alarm apparatus (10) is provided which has a housing defining a body (16). A heat sensor (12) extends from the body; and a cage (24), which defines an enclosure in which the sensor (12) is located. The cage (24) has openings therein to allow for gas to flow freely therethrough. The cage (24) is movable relative to the housing and movement of the cage (24) activates a test/reset switch (46) of the apparatus (10).

The present invention relates to a heat alarm device.

Heat alarm devices for sensing heat, for example from a fire, are well known in the art.

Typically such heat alarms comprise a body containing control and drive circuitry, a heat sensor extending from the body and a cage located around the heat sensor in a manner that allows free flow of air past the sensor. The cage is rigid and is typically made of such a size that it stands well clear of the sensor such that its thermal mass has minimum impact on the response of the sensor to a rise in ambient temperature.

The cage is necessary to present the heat sensor at a position removed from the large thermal mass of the electronics and body of the alarm, whilst also protecting the heat sensor from damage, and preventing the sensor (which will be attached to a source of electricity) being accidentally touched by anyone.

The sensor is generally centrally located so that the effect of the thermal mass of the body is substantially equal irrespective of the direction from which the heat originates (e.g. there is no heat shadow created by off-setting the sensor) and the protective cages are generally quite large relative to the sensor so that air can freely circulate around the sensor.

As a result of the above, the test/reset button used for testing the alarm, or resetting it after an activation, is usually a small button placed on one side of the alarm. As such, as the alarm devices are typically ceiling mounted, it can be hard to activate, in particular for older people who may have reduced mobility, for example those who cannot easily use a step ladder, or stand on a chair.

It is the purpose of the present invention to provide an improved heat detector.

According to the present invention there is provided a heat alarm apparatus comprising a housing defining a body and a heat detection means extending from said body. A protection means defining an enclosure between said housing and said protection means in which said detection means is located is also provided. The protection means has openings therein to allow for the free flow of gas therethrough; and the protection means is movable relative to said housing so as to activate a test/reset switch of said alarm apparatus.

The protection means is preferably substantially centrally mounted on one face of the heat alarm. The housing may have attachment means configured for mounting the alarm apparatus on a first side thereof, and said protection means may be located on a second side of the housing opposite said first side.

The housing can comprise a recess therein and the protection means can be partially received in the recess.

Preferably the protection means comprises a solid central area and a plurality of legs extending therefrom. The solid central area may have a concave surface. The diameter of the protection means may be at least 2 cm. The diameter of the protection means may be at least 3 cm. The diameter of the concave surface may be at least 2 cm.

An electrical circuit board is preferably enclosed within the housing and movement of said protection means activates a switch on said circuit board. A spring can resiliently bias the protection means away from said housing. The spring may comprise a cantilever spring formed as a part of said housing. The protection means can be retained relative to the housing by two or more spring clips.

In one embodiment the heat alarm can comprise a sensing module, said sensing module comprising: a base, the heat detection means, a circuit for driving said heat detection means, and said protection means; and said sensing module is movable relative to the housing to activate said test/reset switch. The enclosure is formed between said protection means and said base.

The base may have a three dimensional textured surface to increase its heat absorption, the three dimensional textured surface may comprise an array of pyramids. Optionally the base may be black, which may be matt black, on at least a side facing said heat sensor.

The housing may comprise a recess therein in which said protection means may be partially received; and said housing may comprises a recess lower surface attached to the housing by a plurality of cantilever springs.

In one embodiment the lower surface is substantially circular and has a sidewall therearound; and the sensing module has a plurality of extensions extending radially therefrom. The alarm of this embodiment further comprises a plurality of features each comprising two steps formed in said sidewall such that at the first step the height of the sidewall is reduced to a first reduced height and at the second step the height of the sidewall is reduced to a second reduced height; and a plurality of protrusions located radially outside of, and adjacent to, the sidewall, said protrusions being aligned with the second step, and attached to the sides of the recess. The steps and protrusions are located such that when the sensing module is located in the recess, said protrusions align with said steps. When the springs are not deformed the distance between top of the first step and the lower surface of the protrusion is less than the thickness of the extensions of the sensing module. This arrangement allows for a very secure attachment of the sensing module to the alarm housing as described hereinbelow, and prevents the accidental removal of the sensor housing.

Specific embodiments of the invention are described below, by way of example, with reference to the drawings, in which:

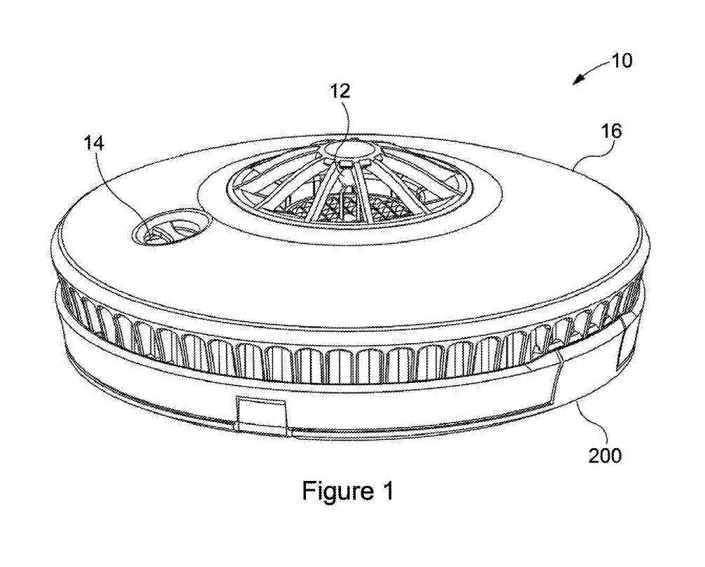

FIG. 1 shows a perspective view of a first embodiment of a heat alarm apparatus in accordance with the invention;

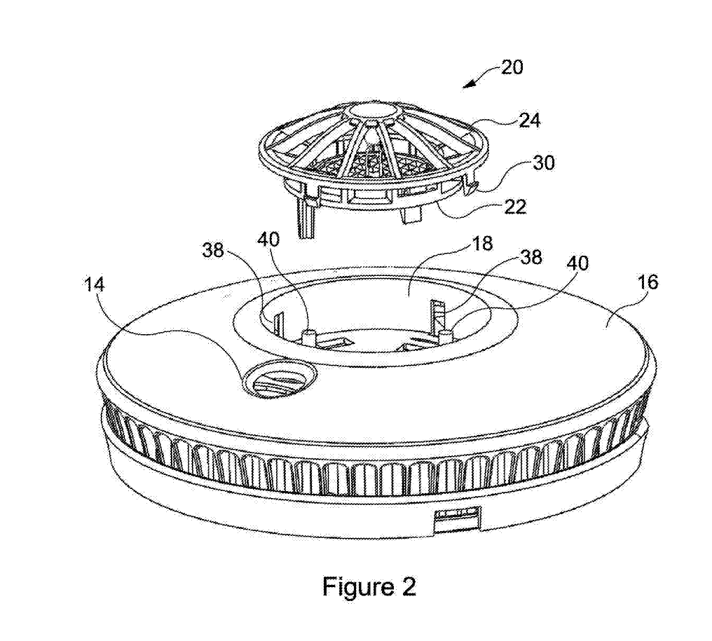

FIG. 2 shows a partially exploded view of the heat alarm of FIG. 1;

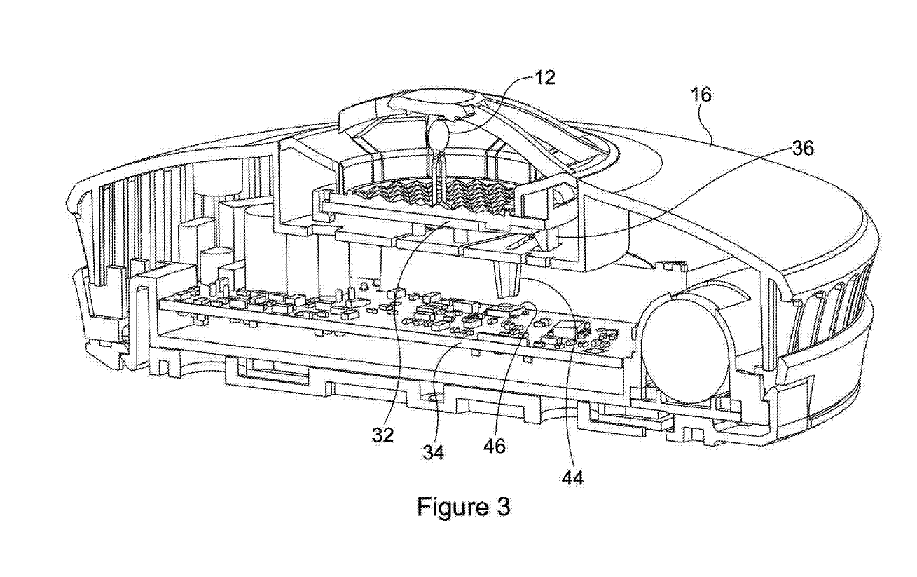

FIG. 3 shows a section view of the heat alarm of FIG. 1;

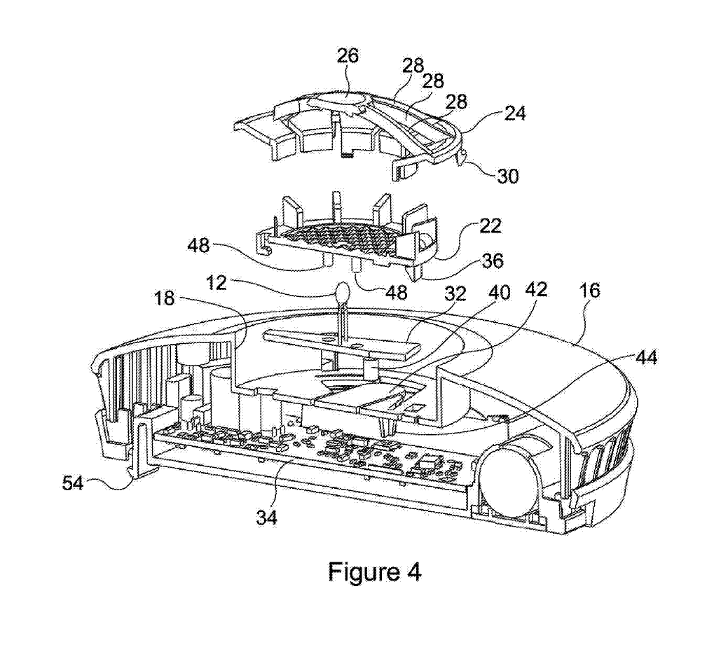

FIG. 4 shows an exploded section view of the alarm of FIG. 1;

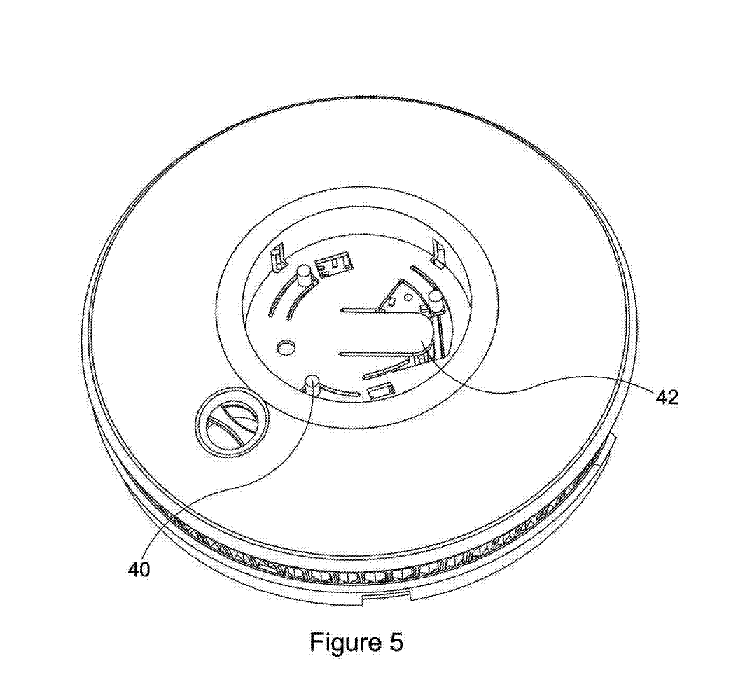

FIG. 5 shows a perspective view of the top of the alarm of FIG. 1 with the sensing module omitted;

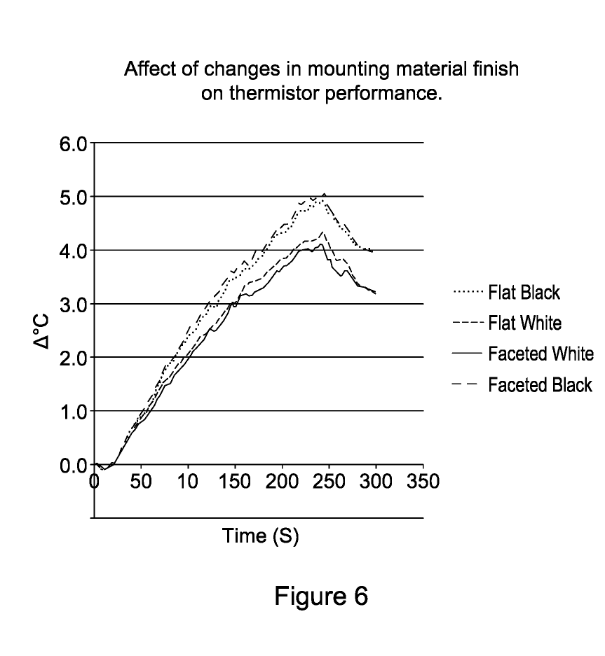

FIG. 6 shows the response times of the alarm of FIG. 1 with different specifications for the base section;

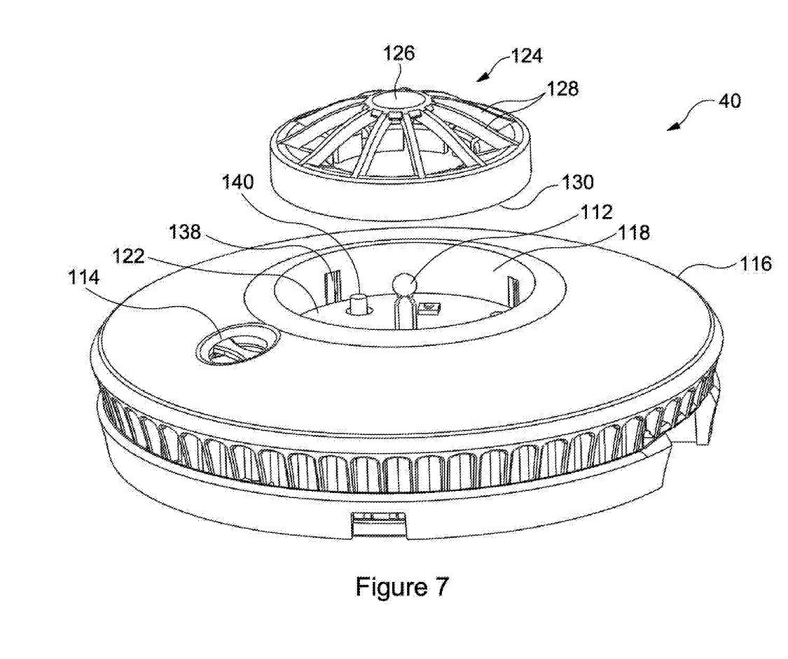

FIG. 7 shows partially exploded perspective view a second embodiment of a heat alarm apparatus in accordance with the invention;

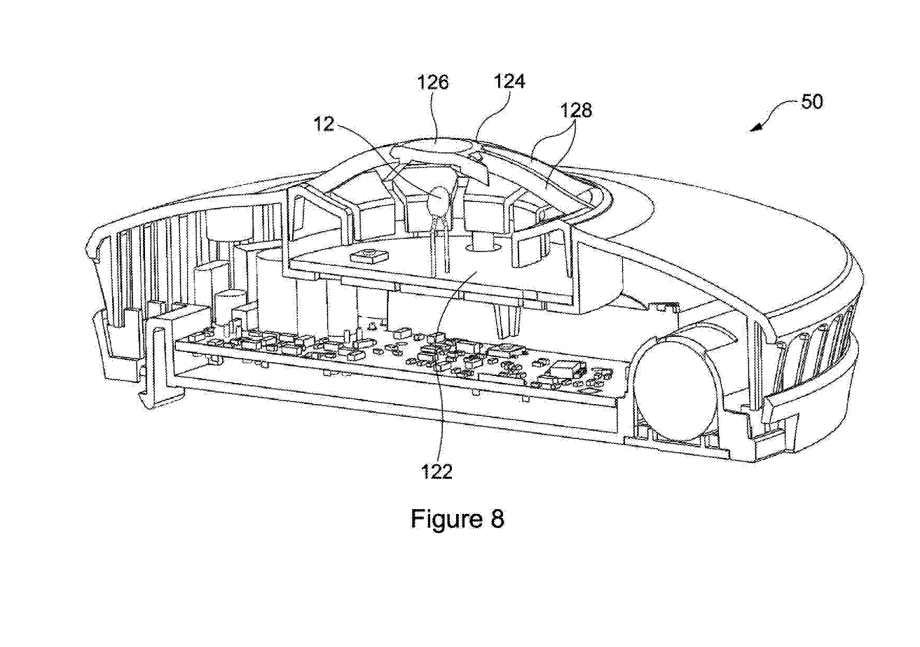

FIG. 8 shows a perspective section view of the second embodiment of the invention;

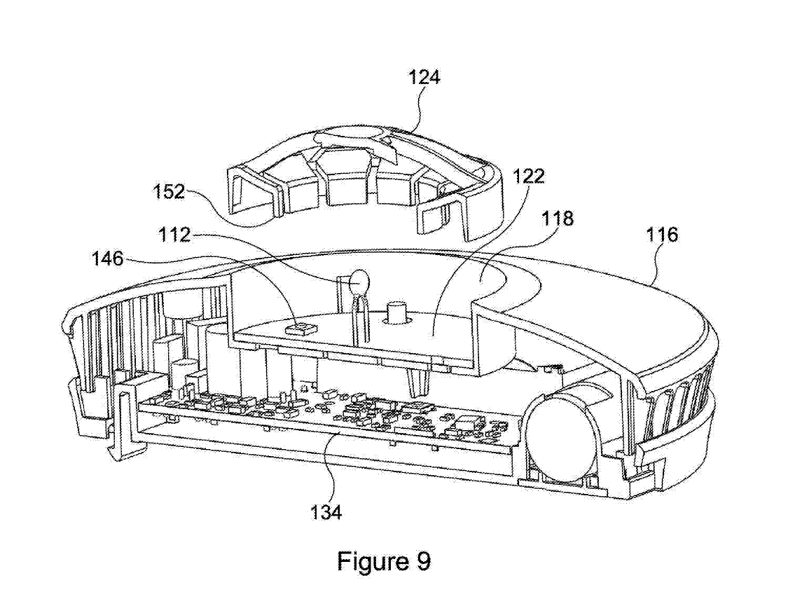

FIG. 9 shows a section view of FIG. 7;

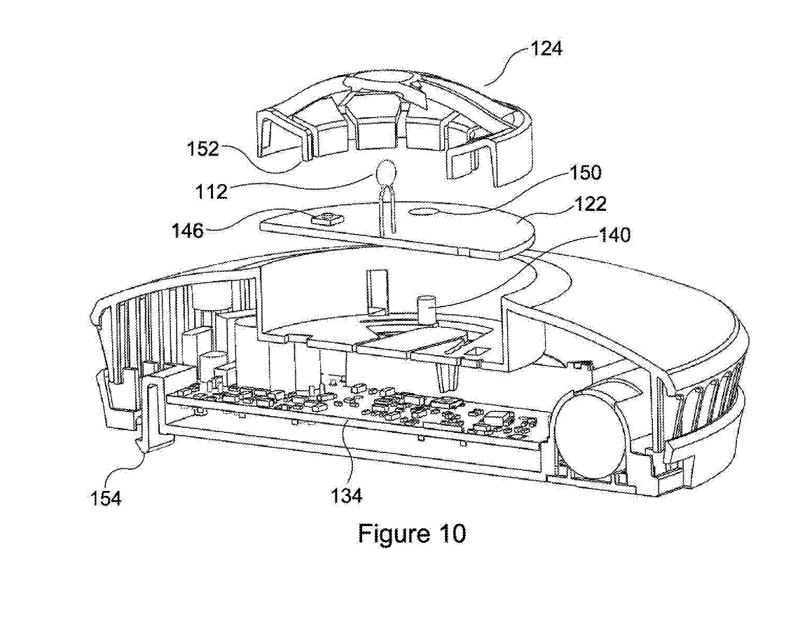

FIG. 10 shows an exploded section view of the second embodiment of the heat alarm apparatus;

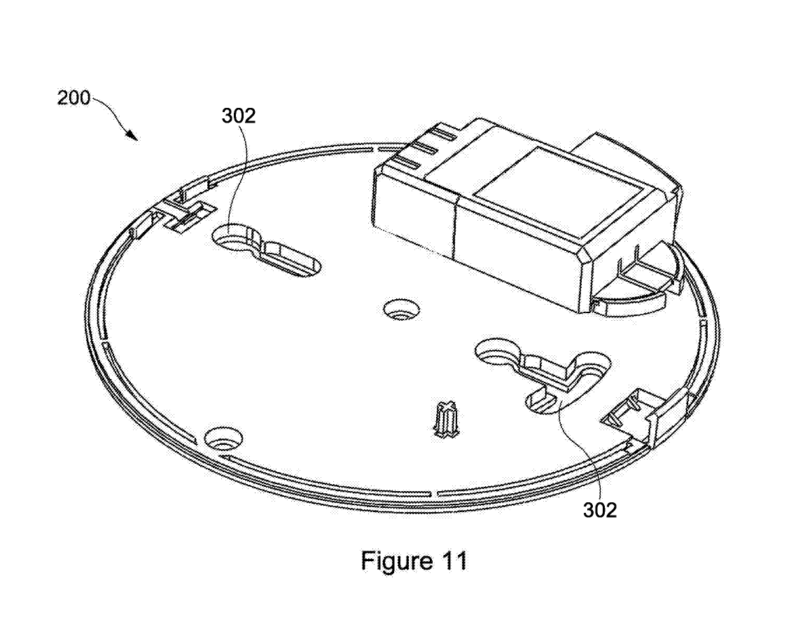

FIG. 11 shows a mounting plate for the alarm apparatus of the invention;

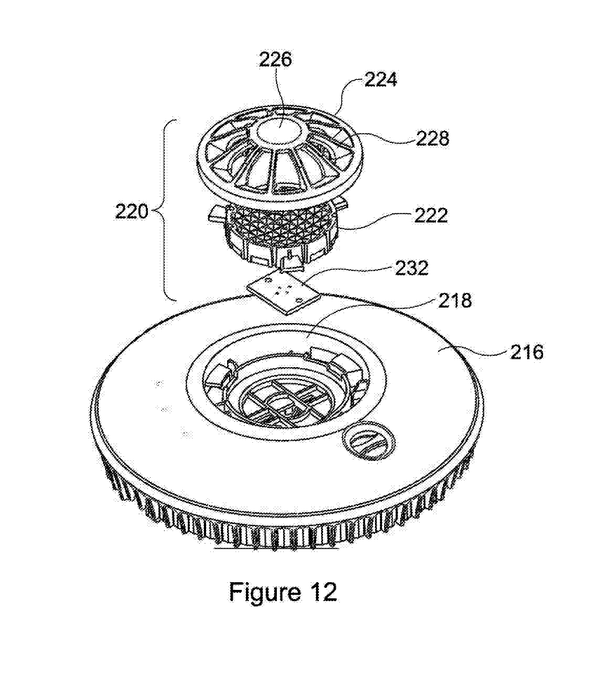

FIG. 12 shows an exploded view of a third embodiment of the invention;

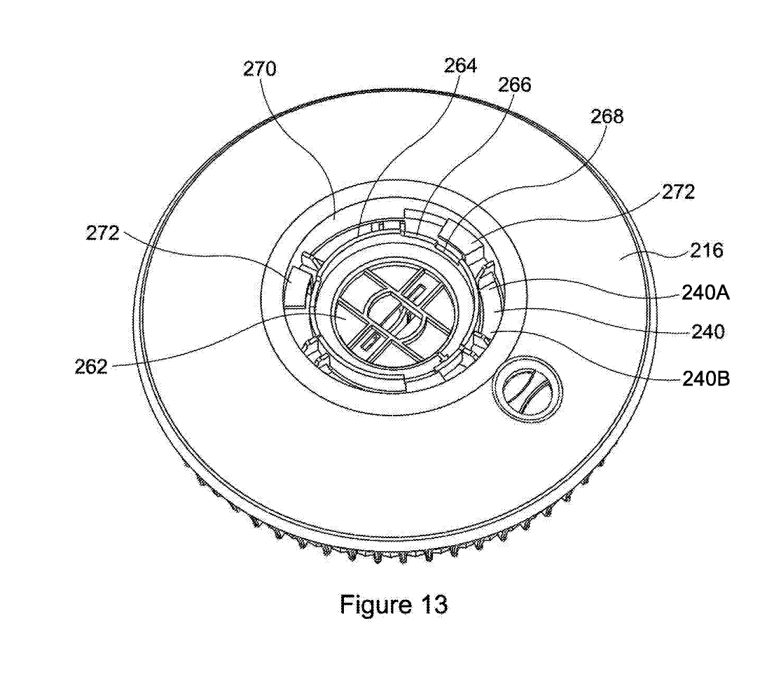

FIG. 13 shows a perspective view of the top of the housing body of the third embodiment of the invention;

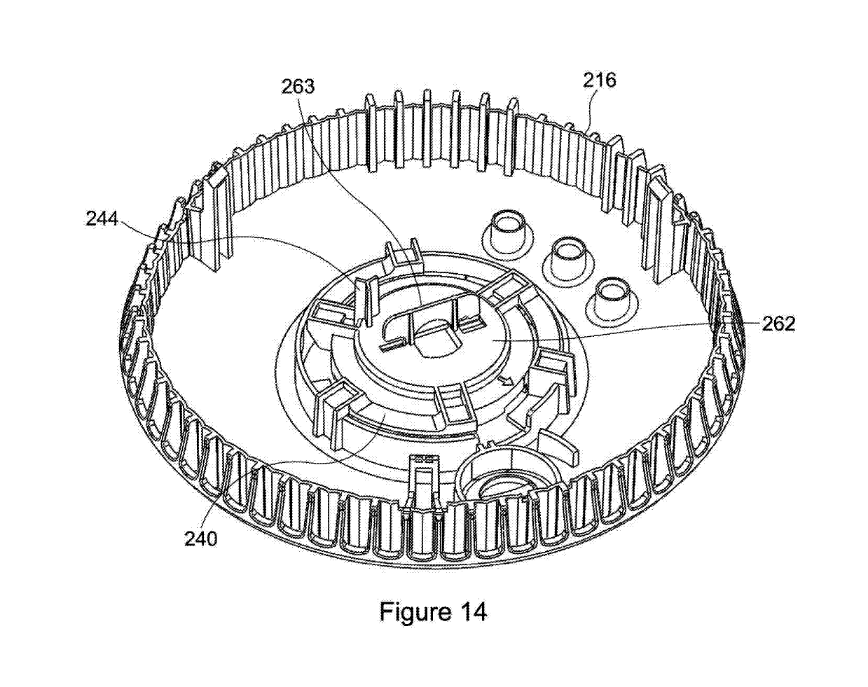

FIG. 14 shows a perspective view of the bottom of the housing body of the third embodiment of the invention; and

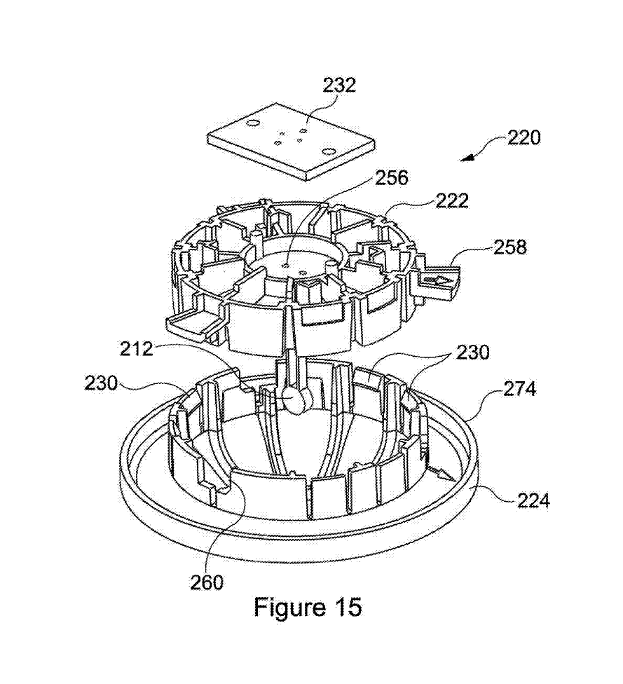

FIG. 15 shows an exploded view of the sensor button assembly of the third embodiment of the invention.

Referring to FIGS. 1 to 5 a heat alarm apparatus 10 is shown. The heat alarm has a heat sensor 12, which is for example a thermistor that in use detects a change in the temperature of the environment in which the alarm apparatus is located and sounds an alarm via a speaker 14 to indicate a change in temperature. The alarm may be used for detecting a fire. The housing body 16 is attached to a base 200 (see FIG. 11).

The alarm has a body 16 that encloses electronic circuitry 34 for powering the sensor 12 and emitting an alarm via the speaker 14 in response to a detected heat change. The electronic circuitry can raise the alarm based on a predefined temperature being sensed, on a rate of temperature rise being sensed, a combination of the two, or any other temperature detection or change criteria known in the art and useful as an indicator of a fire.

The body 16 has a recess 18 in the middle in which a sensing module 20 is received. The sensing module has a base section 22 and a protection means 24 which together define an enclosure in which the sensor 12 is located. The base 22 has a hole therein through which the sensor 12 projects into the enclosure. The protection means 24 comprises a solid central part 26 which has a concave surface of at least 2 cm diameter, and a plurality of cage like ribs 28 extending therefrom to form a cage like structure.

In use air can freely pass between the ribs 28 so that the sensor 12 can detect changes in the air temperature.

The base section 22 and the protection means 24, or cage, clip together forming the enclosure, which is provided with spring clips 30 on its outer surface. Although shown attached to the protection means 24 it will be appreciated that the spring clips 30 may be provided on the base 22 without departing from the invention.

The spring clips 30 locate in channels 38 provided in the recess 18 in a manner that restricts maximum movement but allows for limited movement within the recess 18 in the direction of the channels 38.

The heat sensor 14 is attached to a circuit board 32, which clips to the bottom of the base section 22 by clip 36 and forms part of the sensing module. The circuit board 32 forms part of the sensing module 20.

In this manner the entire sensing module 20 can slide in the recess 18. Springs 40 bias the sensing module into an outermost position in which the sensing module 20 is extended at a maximum position from the body 16 and wherein pressure on the protection means 24 in a direction towards the recess will cause the sensing module to move within the channels 38 against the bias of the springs.

The springs 40 comprise a small boss attached to a cantilever spring which is formed as part of the same plastics moulding as the body 16. Three springs 40 are positioned symmetrically in the recess 18 so that an even biasing force is provided on the sensing module 20, although it will be appreciated that different types or numbers of springs may be used providing that a sufficient biasing force is provided on the sensing module to return it to an extended position after deformation.

Also provided in the recess 18 is a button actuator cantilever spring 42 which has an actuator extension 44 depending therefrom which is aligned so as to be positioned adjacent and spaced from a test/reset button 46 on the electronic circuitry 34.

The base section 22 of the sensing module 20 is provided with actuator columns 48 which extend through the circuit board 32 so that when the sensing module is depressed against the springs 40 so that it moves towards the body 16, the actuator fingers 48 press on the button actuator leaf spring 42 which in turn deflects to press on the test/reset button 46.

In the embodiment described above the heat detector is provided with a large sensing module which includes the protection means or cage 24 to protect the heat sensor, and which large sensing module also doubles up as the test/reset button. This presents a large target for performing a test or reset of the device and as such is easily actuable from floor level by, for example, pressing it with a long stick, for example a broom handle or even a walking stick. The concave surface facilitates the pressing with a stick, which will often have a convex rounded end. This greatly facilitates the ease with which a person with restricted mobility can use the device as it reduces the necessity for the user to climb steps or a chair to reach the small offset test/reset button of previous designs which like the present design would in normal use be ceiling mounted. In addition, by using the sensing module as the test/reset button, a large button can be achieved without having to increase the size of the rest of the device and which enables a large button to be used without disturbing the alarm symmetry which is beneficial in reducing heat shadow effects that would occur if a similar style button were placed alongside the heat sensor of current designs of heat detector alarm apparatus.

In order to improve the performance of the heat detector 12 the side of the base section 22 facing the heat sensor 12 is provided with a surface texture that comprises a plurality of shallow pyramids which in this embodiment are square based pyramids, although it will be appreciated that other surface textures or other pyramids having a different shaped base may be used. The surface of the pyramids is preferably a dark matt colour, for example matt black. It has been shown that using these geometries and using a dark matt surface can increase the response time of the temperature sensor as shown in FIG. 6. Under identical test conditions the temperature measured by the thermistor 12 was recorded over time as the external temperature was increased.

As clearly demonstrated both changing the colour of the surface of the base section 22 facing the thermistor 12 to a black colour and introducing a surface texture in the way of a faceted face increased the speed at which the sensor 12 was able to measure the increase in temperature. As will be appreciated, in detecting fire the response times of a system are very important and accordingly these features enable an increased response time.

Referring now to FIGS. 7 to 10 a second embodiment of the invention is shown. In this embodiment a heat alarm apparatus 110 is shown. The heat alarm has a heat sensor 112, which is for example a thermistor that in use detects a change in the temperature of the environment in which the alarm apparatus is located and sounds an alarm via a speaker 114 to indicate a change in temperature. The alarm may be used for detecting a fire.

The alarm has a body 116 that encloses electronic circuitry 134 for detecting a signal from the sensor 112 and emitting an alarm via the speaker 114 in response to a detected heat change. The electronic circuitry 134 can raise the alarm based on a predefined temperature being sensed, on a rate of temperature rise being sensed, a combination of the two, or any other temperature detection or change criteria known in the art and useful as an indicator of a fire.

The body 116 is provided with a recess 118 located centrally therein as in the first embodiment. Located within the recess is a circuit board 122 to which a heat sensor 112, for example a thermistor, is attached. The circuit board 122 may contain drive electronics for the sensor 112.

A protection means 124 is located in the recess 118 which forms an enclosure between it and the recess 118 in which the sensor 112 is located. As in the first embodiment, the protection means 124 comprises a solid central part 126 which has a concave surface of at least 2 cm diameter, and a plurality of cage like ribs 128 extending therefrom to form a cage like structure.

In use air can freely pass between the ribs 128 so that the sensor 112 can detect changes in the air temperature.

The protection means 124, or cage, is provided with spring clips 130 on its outer surface. The spring clips 130 locate in channels 138 provided in the recess 118 in a manner that restricts maximum movement but allows for limited movement within the recess 118 in the direction of the channels 138.

In this manner the protection means 124 can slide in the recess 118. Springs 140 bias the sensing module into an outermost position in which the protection means 124 is extended at a maximum position from the body 116 and wherein pressure on the protection means 124 in a direction towards the recess will cause the sensing module to move within the channels 138 against the bias of the springs 140. Holes 150 are provided in the circuit board 122 through which the springs 140 extend. Although only one is shown in the section views it will be appreciated that the springs 140 are moulded in the same manner as the springs 40 shown in FIG. 5 and that a plurality of them are provided in the recess 118.

A test/reset button 146 is provided on the circuit board 122 and as the protection means 124 is pressed into the recess a lower surface 152 thereof comes into contact with the test/reset button 146 so as to actuate it.

Although not shown it will be appreciated that the circuit board 122 may be provided with a matt black and/or textured surface as disclosed in relation to the first embodiment. Alternatively an additional component (not shown) having a matt black and/or textured surface can be included between the circuit board 122 and the protection means 124. As will be appreciated holes for the thermal sensor 112 and springs 140 will be provided in any such component which will be attached in the bottom of the recess so that it can not move in use.

The second embodiment functions in the same manner and offers the same advantages as the first embodiment in that the large central button for the test/reset function is provided.

Referring to FIGS. 12 to 15 a third embodiment of the invention is shown. This embodiment differs from those shown in FIGS. 1 to 10 in that the sensing module 220 is mounted in the housing body 216 in a different manner. It will be appreciated that the parts shown in FIGS. 12, 13 and 14 only show one half of the body housing and in practice a lower part would also be provided to enclose the interior space of the alarm as shown in FIGS. 1-10.

Referring first to FIG. 15 the sensing module 220 is shown which comprises four parts, a protective cage 224, a base section 222 that has thereon a concave reflective surface (see FIG. 12) which may optionally be provided with an array of surface features, for example square based prisms, a circuit board 232, and a heat sensor 212. The base section 222 is provided with one or more holes 256 through which electrical connectors of the heat sensor 212 can pass so that, when assembled, the sensing part of the heat sensor 212 is located in a space formed between the concave surface of the base section 222 and the protective cage or protection means 224 and the electrical connectors thereof pass through the holes 256 in the base section so that they can make electrical contact with the circuit board 232 on the other side thereof.

Although shown and described as being concave it will be appreciated that a flat reflective surface could also be used as described in relation to the previous embodiments.

The base section has extensions 258 thereon which are received in recesses 260 of the protective cage 224 and locate the two parts in rotational alignment. The protective cage 224 has one or more spring clips 230 thereon that are resiliently displaced as the two parts are brought together and which spring back into position to retain the base section 222 when the parts are fully brought together. The protection means 224 comprises a solid central part 226 which has a concave surface of at least 2 cm diameter, and a plurality of cage like ribs 228 extending therefrom to form a cage like structure. These components together form the assembled sensor module 220.

Referring now to FIGS. 13 and 14 the housing body 216 has a recessed portion 218 which receives the sensing module 220. The recess has a lower surface 262 that is resiliently retained by the housing body 216 by a plurality of cantilever type springs 240 located around the recessed portion 218, and which are each attached at one end 240A to the housing body 216 and at the other end 240B to the lower surface 262. In this manner the lower surface 262 is resiliently retained within the recess 218 in a manner such that a force applied thereto along the direction of the central axis of the recess will move the lower surface 262 in that direction, and when the moving force is removed the lower surface will resiliently return to its original position.

The lower surface 262 is circular and has a sidewall 264 therearound. Spaced around the sidewall 264 are a number of stepped features at which the height of the sidewall is stepped down to a first reduced height 266 and is then further stepped down to a second reduced height 268. These stepped sections are spaced to coincide with the extensions 258 when the sensing module 220 is located in the recess 218. Aligned with the second step 266, and attached to the sidewalls 270, are a plurality of protrusions 272 located radially outside of, and adjacent to, the sidewall 264. In its natural position, i.e. the position in which the springs are not deformed, the vertical distance between top of the first stepped feature 266 and the lower surface of the protrusion 272 is less than the thickness of the extensions 258 of the sensing module 220.

When the button assembly is pushed down, the amount of travel is limited by the outer edge 274 of the protective cage 224 interacting with the top surface of protrusion 272, thereby acting as a ‘stop’. Protrusion 272 is robust enough ensure reasonable force cannot deform it, thus ensuring the cage assembly cannot be accidentally disassembled. Therefore the only way to remove the cage assembly from the front cover 216 is by pulling the tab 263 that is connected to surface 262 from the inside of the alarm, to pull the surface 262 past its normal maximum travel. This precludes the need for additional fixing means such as a screw.

To assemble the unit the sensor module 220 is inserted into the recess with the protrusions 258 aligned with the first recessed steps 266. The sensing module is then pressed into the recess to deform the springs 240 and thereby increase the vertical distance between the top of the first recessed steps 266 and the bottom surface of the protrusions 272 such that it is greater than the thickness of the extensions 258 of the sensing module 220. The sensing module 220 is then rotated to move the extensions 258 thereof in alignment with the second recessed steps 268, and is then released.

The sensing module 220 is therefore securely retained in the recess and can not easily be removed without disassembling the heat detector.

As described in relation to the first and second embodiments the housing will contain electronic circuitry to power and control the alarm device. As can be seen in FIG. 14 a switch post 244 extends from the bottom of the lower surface 262 and operates in a similar manner to that described in relation to the extension 44 shown in FIG. 4, i.e. when the sensing module is pressed the extension 244 presses on a switch in a circuit board within the housing.

All three embodiments of the invention will usually be attached to a ceiling in a property, although they may be attached to a wall. A mounting plate 200 as shown in FIG. 11 is shown. The mounting plate 200 is provided with fixing holes 302 by which it can be attached to a wall or other surface, and the alarm is provided with clips 54, 154 by which it is attached to the mounting plate 200 in conjunction with a clip on the baseplate.

1-21. (canceled)

22. A heat alarm apparatus comprising:
a housing defining a body;
heat detection means extending from said body; and
protection means defining an enclosure in which said detection means is located,
wherein said protection means has openings therein to allow for the free flow of gas therethrough, and
said protection means is movable relative to said housing so as to activate a test and/or reset switch of said alarm apparatus.

23. The heat alarm according to claim 22, wherein said protection means is substantially centrally mounted on one face of the heat alarm.

24. The heat alarm according to claim 22, wherein the housing has attachment means on a first side thereof configured for, in use, mounting said alarm apparatus, and wherein said protection means is located on a second side of the housing opposite said first side.

25. The heat alarm according to claim 22, wherein said housing comprises a recess therein and wherein said protection means is partially received in said recess.

26. The heat alarm according to claim 22, wherein the protection means comprises a solid central area and a plurality of legs extending therefrom.

27. The heat alarm according to claim 26, wherein the solid central area has a concave surface.

28. The heat alarm according to claim 22, wherein the diameter of the protection means is at least 1.5 cm.

29. The heat alarm according to claim 22, wherein the diameter of the protection means is at least 2 cm.

30. The heat alarm according to claim 22, wherein an electrical circuit board is enclosed within said housing and wherein movement of said protection means activates a switch on said circuit board.

31. The heat alarm according to claim 22, further comprising at least one spring that resiliently biases the protection means away from said housing.

32. The heat alarm according to claim 31, wherein said spring comprises a cantilever spring formed as a part of said housing.

33. The heat alarm according to claim 22, in which the protection means is retained relative to the housing by at least two spring clips.

34. The heat alarm according to claim 22, comprising a sensing module, said sensing module comprising:
a base, said heat detection means, a circuit for driving said heat detection means, and said protection means, wherein said enclosure is formed between said protection means and said base, and wherein said sensing module is movable relative to the housing to activate said test/reset switch.

35. The heat alarm according to claim 34, wherein said base has a three dimensional textured surface.

36. The heat alarm according to claim 35, wherein said three dimensional textured surface comprises an array of pyramids.

37. The heat alarm according to claim 34, wherein said base is black on at least a side facing said heat sensor.

38. The heat alarm according to claim 34, further wherein
said housing comprises a recess therein and wherein said protection means is partially received in said recess; and
said housing comprises a recess lower surface attached to the housing by a plurality of cantilever springs.

39. The heat alarm according to claim 38, wherein:
said lower surface is substantially circular and has a sidewall therearound; and
said sensing module has a plurality of extensions extending radially therefrom; the alarm further comprising:
a plurality of features each comprising two steps formed in said sidewall such that at the first step the height of the sidewall is reduced to a first reduced height and at the second step the height of the sidewall is reduced to a second reduced height; and
a plurality of protrusions located radially outside of, and adjacent to, the sidewall, said protrusions being aligned with the second step, and attached to the sides of the recess; and
wherein said steps and said protrusions are such that when the sensing module is located in the recess, said protrusions align with said steps; and when said springs are not deformed the distance between top of the first step and the lower surface of the protrusion is less than the thickness of the extensions of the sensing module.
